(19) United States
(12) Patent Application Publication
(10) Pub. No.: US 2023/0369635 A1
(43) Pub. Date: Nov. 16, 2023

(54) UNIT BATTERY FOR MANUFACTURING BATTERY MODULE OR BATTERY PACK

(71) Applicants: Sung Kyun CHANG, Daegu (KR); Jung Yeoul SHIN, Daegu (KR)

(72) Inventors: Sung Kyun CHANG, Daegu (KR); Jung Yeoul SHIN, Daegu (KR); Yirae CHANG, Daegu (KR)

(21) Appl. No.: 18/030,101

(22) PCT Filed: Sep. 28, 2021
(86) PCT No.: PCT/KR2021/013277

§ 371 Date: Apr. 4, 2023

(30) Foreign Application Priority Data
Oct. 7, 2020 (KR) 10-2020-0129150

(51) Int. Cl. H01M 10/04; H01M 50/593; H01M 50/105; H01M 10/6554; H01M 50/516; H01M 50/211

(52) U.S. Cl. CPC H01M 10/0431; H01M 50/593; H01M 50/105; H01M 10/6554; H01M 50/516; H01M 50/211

(57) ABSTRACT

Disclosed is a unit battery for manufacture of battery modules or battery packs, the unit battery including an electrode assembly mounted in a cell case, the electrode assembly being capable of being reversibly charged and discharged, a positive electrode body portion, to which a positive electrode of the electrode assembly is connected, the positive electrode body portion being configured to serve as a positive electrode terminal for external connection while forming one surface of the cell case, a negative electrode body portion, to which a negative electrode of the electrode assembly is connected, the negative electrode body portion being configured to serve as a negative electrode terminal for external connection while forming the other surface of the cell case, and an insulation portion configured to electrically insulate the positive electrode body portion and the negative electrode body portion from each other.

### TECHNICAL FIELD

The present invention relates to a unit battery for manufacture of battery modules or battery packs, wherein major portions of a cell case constitute a positive electrode terminal and a negative electrode terminal.

### BACKGROUND ART

With rapid increase in mobile devices, the number of mobile energy sources has been increased. In order to solve an environmental problem, the number of electric vehicles as an alternative to conventional vehicles using fossil fuels has been increased. In addition, the demand for energy storage systems capable of storing variable renewable energy, such as sunlight and wind power, which are environmentally friendly sustainable energy sources, has also increased. As a result, the application range of secondary batteries has gradually been widened, and the market therefor has abruptly been extended. In particular, a lithium secondary battery has attracted attention due to high density and high performance thereof. In addition, a network attached storage (NAS) and a flow battery have also been developed. However, the network attached storage and the flow battery are inferior to the lithium secondary battery in terms of use convenience and energy density.

It has been about thirty years since lithium secondary batteries were commercialized, and materials for e lithium secondary batteries have been developed. For a positive electrode active material, LiCoO₂, which was developed first, has been replaced with LiMn₂O₄, LiFePO₄, and NMC having various compositions, such as LiNi_{1/3}Mn_{1/3}Co_{1/3}O₂ and LiNi_{0.5}Mn_{0.3}Co_{0.2}O₂. In recent years, the positive electrode active material has been configured to have a layered structure while the content of Ni is increased, whereby the capacity of the positive electrode active material has been increased. Research to enhance the structure, e.g. cation substitution of a six-coordinate or four-coordinate replaceable element, such as Ti, Zr, Al, or Mg, and anion substitution of F or S, has been conducted, and surface treatment to minimize reaction between an electrolytic solution and a positive electrode using various elements, such as Al, B, and W, has also been actively and widely developed. For a negative electrode material, natural graphite, artificial graphite, silicon, a silicon composite, a silicon alloy, lithium (Li) metal, etc. have been deeply and widely developed, whereby capacity increase and performance improvement have been achieved.

However, demand for price reduction and energy enlargement in the market has continued, and finding a new breakthrough using only the materials has reached the limit.

Unlike development of the materials, the structure of a battery has not greatly changed from a cylindrical structure, a pouch-shaped structure, and a prismatic structure. When the battery is used as a unit battery in manufacturing a battery module or a battery pack, the structure of the battery may have an important meaning. In connection therewith, relevant terms will be described based on some technical concepts as follows.

The term “unit battery” means a minimum unit battery that can be handled, and the unit battery may be connected to a positive electrode terminal and a negative electrode terminal of a target that needs electric power in order to supply electric power to the target. The term “battery module” means a modular assembly in which a plurality of unit batteries is connected to each other in series or in parallel, and the term “battery pack” means an assembly in which a plurality of battery modules is connected to each other in series or in parallel or a plurality of unit batteries is connected to each other in series or in parallel so as to be suitable for the final use.

A unit battery includes a kind of electrode cell constituted by a positive electrode, a negative electrode, and a separator, and the electrode cell has a stack cell structure or a roll cell structure. Since the electrode cell is a component included in the unit battery, the electrode cell is not an object to be individually handled in order to directly supply electric power to a target, such as the unit battery.

For an all-solid-state battery, electrode cells may be connected to each other in series, and no electrolytic solution flows therein, and therefore no additional structure is necessary. When a liquid electrolytic solution-based battery has a series connection structure, however, it is necessary to provide an additional part configured to prevent leakage of an electrolytic solution. As a result, serious problems, such as reduction in energy density, increase in number of parts, process complexity, and price increase, may occur during production and operation of the battery. The operation voltage of a liquid electrolytic solution is low. Even though current leakage occurs to a minimum, therefore, a serious safety-related problem may occur. In the unit battery, therefore, the electrode cells are generally electrically connected to each other in parallel.

When the unit battery used as a unit battery in manufacturing a battery module or a battery pack is a cylindrical battery, there is a fundamental structural limit in that it is difficult to reduce a dead space or a dead volume generally formed during packing. In addition, it is difficult to increase the size of the unit battery due to limits in steel forming. For these reasons, a medium or large polymer battery and a medium or large prismatic battery are mainly used as the unit battery in the market for energy storage systems (ESS) and electric vehicles (EV), which require large-capacity batteries. However, the polymer battery and the prismatic battery also have limits that cannot be structurally overcome.

The limits of conventional battery structures will be described hereinafter in more detail.

A conventional cylindrical battery has a circular shape when the cylindrical battery is used as a unit battery of a battery module or a battery pack. The energy density of the cylindrical battery is high. Since a battery receiving space in each of most information technology (IT) devices is formed in the shape of a rectangular parallelepiped, however, a large dead space is formed when the cylindrical battery is used. An electric vehicle (EV) and an energy storage system (ESS), the use of which has suddenly increased, essentially require large capacity and high voltage. As a result, a plurality of batteries is connected to each other while being stacked. If the cylindrical structures are stacked, however, a dead space is inevitably formed. In addition, deep forming is necessary due to the cylindrical structures; however, enlargement is difficult due to structural limits in forming. Enlargement was tried by some companies;

however, there is no company having competitiveness capable of entering the actual market. In the electric vehicle (EV) and the energy storage system, therefore, the medium or large pouch-shaped battery and the medium or large prismatic battery are mainly used.

However, careful and deep research on the pouch-shaped battery and the prismatic battery reveals structural limits of the pouch-shaped battery and the prismatic battery.

First, for the pouch-shaped battery, as shown in FIGS. 1A and 1B, a positive electrode tab and a negative electrode tab are used as electrode terminals for connection of a positive electrode and a negative electrode, and it is necessary to provide a space for sealing the pouch; however, a dead space is formed in such a sealing region. In addition, when a plurality of unit batteries is connected to each other in order to constitute a battery module, as shown in FIGS. 2A and 2B, it is necessary to provide an additional connection member for electrical connection between the unit batteries, such as welding, a wire, a busbar, or a wire harness. As a result, energy density is reduced and electrical resistance is increased, which are important limits.

For the prismatic battery, as shown in FIG. 4, a positive electrode tab and a negative electrode tab are necessary as electrode terminals for connection of a positive electrode and a negative electrode. When a plurality of unit batteries is connected to each other in order to constitute a battery module, as shown in FIG. 5, it is necessary to conduct welding or to provide a wire, a busbar, or a wire harness, in the same manner as in the pouch-shaped battery.

As can be seen from the drawings mentioned above, each of the pouch-shaped battery and the prismatic battery has many parts that reduce energy density thereof and many spaces that reduce energy density thereof.

In addition, when batteries are connected to each other, the batteries are connected to each other via very narrow terminals by welding, whereby electrical resistance is increased and heat is generated. This is proven from a very simple physical formula. The electrical resistance is increased in inverse proportion to the distance and the area (R∝1/A), and the heat is increased in proportion to the electrical resistance (H=I²R →H∝R∝1/A).

Deep research on a battery module or a battery pack including conventional batteries connected to each other reveals that the battery module or the battery pack has a structure in which energy density is low and resistance is high. The battery module or the battery pack is further vulnerable in the EV and the ESS, which require large capacity and high energy density, and therefore it can be seen that the limits of the battery module or the battery pack are clear. In addition, welding, which causes physical/chemical deformation of the battery, may cause problems of expense increase, recovery rate reduction, and quality deterioration in terms of the reuse or recycling of the battery, the demand for which has increased in recent years.

Therefore, there is a high necessity for new technology capable of solving the above problems.

### DISCLOSURE

### Technical Problem

Therefore, the present invention has been made to solve the above problems, and other technical problems that have yet to be resolved.

As the result of deep research and a variety of simulation, the inventors of the present application have developed a unit battery having a novel structure configured such that, when a plurality of unit batteries is connected to each other in order to constitute a large-capacity, high-energy-density battery module or battery pack used in an energy storage system (ESS) or an electric vehicle (EV), it is possible to maximize energy density and electrical performance and to reduce resistance and heat while minimizing an additional space for a wire harness or welding and relative expense during series/parallel connection.

### Technical Solution

A unit battery for manufacture of battery modules or battery packs according to the present invention includes an electrode assembly mounted in a cell case, the electrode assembly being capable of being reversibly charged and discharged, a positive electrode body portion, to which a positive electrode of the electrode assembly is connected, the positive electrode body portion being configured to serve as a positive electrode terminal for external connection while forming one surface of the cell case, a negative electrode body portion, to which a negative electrode of the electrode assembly is connected, the negative electrode body portion being configured to serve as a negative electrode terminal for external connection while forming the other surface of the cell case, and an insulation portion configured to electrically insulate the positive electrode body portion and the negative electrode body portion from each other.

That is, in the unit battery for manufacture of battery modules or battery packs according to the present invention, the positive electrode and the negative electrode occupy major portions of an outer surface of the cell case, whereby large-area electrode terminals are formed.

Necessity of the unit battery according to the present invention and advantages thereof will be described below. Unless described otherwise in this specification, the term “battery” may be understood as a “unit battery”.

The unit battery having the novel structure according to the present invention implements a battery most suitable for a next-generation mobile energy source, such as an xEV, ESS, or VTOL aircraft, which requires large area and high capacity. To this end, it is very important for not only the unit battery but also a battery module or a battery pack constituted by unit batteries connected to each other to be capable of being reused or recycled, and deep observation and efforts are required in terms of battery industry, battery process, and battery utilization. As a result, it is possible to achieve a distributed energy resource (DER), which is a topic of the quaternary industry, and an energy source that can be reused or recycled in an environmentally friendly state, and this may greatly contribute to worldwide effects, such as carbon neutrality.

Key elements required for a high-capacity, large-area battery in recent years are as follows: energy density increase, which is an invariable goal of the battery as an energy source; resistance reduction that can satisfy high output requirements, such as in an xEV, ESS, or VTOL aircraft; battery resistance reduction and resistance reduction in a module/pack structure in which a connection portion between batteries is necessary; thermal conduction necessary to control heat generated due to high energy density and high output; and process simplification and the provision of safety in terms of reuse and recycling as well as the battery manufacturing process and the module/pack manufacturing process depending on enlargement of the battery. In an environmentally friendly aspect, one very important topic is added. This is the reuse of a battery and the reuse of a part or material used. The present invention has been implemented based on overall understanding of the use of the battery, the relationship between the module/pack and the battery, the battery manufacturing process and subsequent processes, and the reuse or recycling of the battery after the use of the battery as well as understanding of the battery, and proposes the best solution to principal requirements of the battery presented in recent years through the novel battery.

The importance of the recent batteries mentioned above will be described hereinafter for each item in connection with the unit battery according to the present invention.

(a) Energy density increase: In the unit battery according to the present invention, the positive electrode body portion and the negative electrode body portion serving as the electrode terminals are located at the outermost sides of the unit battery, whereby an additional positive electrode tab and an additional negative electrode tab are not necessary, and batteries can be connected to each other with minimum welding or without welding, whereby it is possible to omit or minimize a wire or a busbar necessary for welding between the batteries. It is possible to maximize the energy density of a module/pack as well as the energy density of the battery and to reduce the number of parts and processes. In addition, it is possible to reduce expense with improvement in energy density.

(b) Resistance reduction: Resistance is very important in high energy density and output required in an xEV, ESS, or VTOL aircraft. When the energy density and the output are high, a large amount of heat is generated in a small space, whereby energy efficiency is reduced. In addition, the heat accumulated in the small space greatly reduces safety of the battery. Consequently, it is necessary to provide an additional cooling structure configured to control the heat generated in the battery, which reduces energy density and increases expense. In the unit battery having the novel structure according to the present invention, the positive electrode body portion and the negative electrode body portion serving as the electrode terminals are located at the outermost sides of the unit battery, and when one unit battery is connected to another unit battery, the unit batteries are brought into large-area contact with each other, whereby it is possible maximize resistance reduction. Since the resistance of electricity is inversely proportional to the electrical contact area, it is possible to reduce resistance and improve energy efficiency, compared to conventional batteries. In addition, heat generation is minimized, whereby it is possible to simplify the cooling structure. In addition, conventional batteries are connected to each other through point contact or line contact. If welding separation occurs due to process quality problems or vibration during the use of the batteries, current may locally flow to a specific point or line, whereby the amount of heat generated is greatly increased. In the worst case, the battery may ignite or explode, or fire may break out in the battery. In contrast, in the connection structure between the batteries based on large-area contact according to the present invention, even though process problems occur or vibration is generated during the use of the batteries, it is possible to minimize increase in the amount of heat due to large-area contact between the batteries, whereby it is possible to prevent performance and safety problems. Each of currently commercialized batteries, such as a cylindrical unit battery, a prismatic unit battery, and a polymer unit battery, has a structure in which point or line contact through welding is essentially required, and therefore it is very difficult and substantially impossible to provide large-area contact, which is provided by the present invention.

(c) Thermal conduction increase: As described in paragraph (b) resistance reduction, heat control is very important during a normal use period of the battery, and it is most preferable to minimize heat through the large contact structure according to the present invention. Since it is impossible to reduce the resistance to 0, however, the best method must be used to control the heat. In the structure according to the present invention, the positive electrode body portion and the negative electrode body portion located at the outermost sides of the unit battery serve as the electrode terminals. To this end, each of the positive electrode body portion and the negative electrode body portion is made of a metal material, and therefore it is possible to rapidly discharge heat generated in the unit battery to the outside through connection with the cooling device. Thermal conductivity of the pouch-shaped unit battery is low since a polymer is located at the outermost sides of the pouch-shaped unit battery, and the surface of the cylindrical unit battery that contacts the cooling structure is small due to the shape of the cylindrical unit battery. The prismatic unit battery is made of a metal can; however, most of the outermost sides of the prismatic unit battery is not an electrical conduction portion in which current flows to directly generate heat but is a portion that physically protects the internal structure of the prismatic unit battery from the outside. In addition, a positive electrode tab and a negative electrode tab are separately provided, whereby heat is concentrated thereon; however, it is very difficult to intensively cool the portions due to complexity of the electrical connection structure. In contrast, in the unit battery having the novel structure according to the present invention, the positive electrode body portion and the negative electrode body portion are located at the outermost sides of the unit battery so as to face each other, whereby it is possible to solve the above problem and to provide the best method of transferring heat from the battery to the cooling device.

(d) Provision of safety during the use of the battery: The battery may be mainly used in three cases, such as use during the battery production process, use by consumers, and use during the A/S process. In consideration of recent increase in usage of batteries, environmentally friendliness, and importance of carbon reduction, such as carbon neutrality, the use of the battery in terms of reuse or recycling is also very important. Until now, safety during use by consumers has mainly been discussed; however, safety during handling of the battery must also be very importantly considered in the situation in which the capacity and size of the battery are greatly increased. In the unit battery according to the present invention, each of the outermost sides of the unit battery is made of a metal material such that the outermost sides of the unit battery can serve as electrode terminals. As a result, the unit battery is very strong against external impact, whereby the unit battery is stable during the battery manufacturing process. Furthermore, since welding is omitted or minimized, it is possible to very easily disassemble the module/pack during reuse or recycling of the battery, whereby it is possible to easily separate individual batteries from each other. This greatly contributes to securing safety of workers who disassemble the module/pack for reuse or recycling or in a factory in which the module/pack is disassembled for reuse or recycling. In addition, it is also possible to reduce expense during the disassembly process. In particular, since the batteries are strongly connected to each other through welding in the conventional battery structure, the batteries are inevitably damaged when the batteries are separated from each other. As a result, safety of workers who handle the batteries may be reduced during reuse or recycling.

(e) ease in reuse or recycling: It is possible to minimize or omit welding due to large-area contact and strong structural characteristics of the positive electrode body portion and the negative electrode body portion, which are the outermost electrode terminals of the unit battery, which is a minimum unit battery when the battery is actually used, as already mentioned several times as the advantage of the present invention. This provides a structure more suitable for carbon neutrality through reuse or recycling, which has been the largest topic all over the world in recent years. Irreversible structural deformation of the battery inevitably occurs due to welding essential in the conventional battery and module/pack structure, whereby disassembly for reuse or recycling is difficult and a danger, such as damage, may occur. In the unit battery having the novel structure according to the present invention, it is possible to provide the best method of minimizing the problems that occur during reuse or recycling of the conventional unit battery, module, and pack.

As can be seen from the above description, the present invention provides the best solution capable of solving the problems with the current battery structure for the full lifespan thereof including use of the actual battery, such as the module or the pack, the manufacturing process, reuse, and recycling of the battery together with improvement of the unit battery, in addition to improvement in energy density of the battery. To this end, in the unit battery having the novel structure according to the present invention, the positive electrode body portion and the negative electrode body portion, which serve as electrode terminals, are located at the outermost sides of the unit battery, at which the unit battery is handled, the unit battery provides strength essential during the handling process, large-area contact is achieved without provision of an additional tab structure, and electrical conductivity and thermal conductivity are excellent, and therefore it is possible to minimize the amount of heat.

In a concrete example, the cell case may be formed in the shape of a hexahedron, and the one surface and the other surface of the cell case formed respectively by the positive electrode body portion and the negative electrode body portion may be outer surfaces symmetric with respect to the center of the hexahedron. For example, the hexahedron may be a regular hexahedron or a rectangular parallelepiped. In particular, it is preferable for the hexahedron to be a rectangular parallelepiped having a depth and a height greater than a width; however, corners or apexes of the rectangular parallelepiped may be rounded in order to adjust workability and mechanical strength.

When the one surface of the positive electrode body portion and the other surface of the negative electrode body portion are two outer surfaces having relatively large areas, among six faces of the cell case, it is possible to implement large-area electrode terminals.

In a concrete example, the total external area (Z) of the unit battery and the difference between the conductive external area (C) of the positive electrode body portion and the conductive external area (A) of the negative electrode body portion may satisfy a relationship of 0≤|(C−A)/Z|<0.5. It is preferable for the difference between the external areas to be greater than the ratio of the conventional weld area (W) to the external area (Z) of the unit battery.

In the conventional unit battery, the weld area is 5% or less of the total external area of the unit battery. The reason for this is that, in the conventional unit battery, the weld area directly affects the capacity, the size, etc. of the unit battery, and therefore the capacity of the unit battery is abruptly reduced when the weld area is increased. In addition, expense incurred to perform a resistance welding process or a laser welding process is inevitably increased as the welding area is increased. In the conventional unit battery, there is a limit in increasing the weld area due to resistance increase and process expense increase.

In contrast, in the unit battery according to the present invention, it is possible to maximize the area of each of the positive electrode body portion and the negative electrode body portion and to prevent increase in process expense, which is very advantageous to resistance reduction through area increase. Preferably, the total external area (Z) of the unit battery and the difference between the conductive external area (C) of the positive electrode body portion and the conductive external area (A) of the negative electrode body portion satisfy a relationship of 0≤|(C−A)/Z|<0.45. As the difference between the external areas is decreased, electrical characteristics may be improved.

In another concrete example, the conductive external area (C) of the positive electrode body portion, the conductive external area (A) of the negative electrode body portion, and the total external area (Z) of the unit battery may satisfy a relationship of 0<(C+A)/Z<1, which may be greater than the weld area of the conventional unit battery. Preferably, a relationship of 0≤|(C−A)/Z|<0.45 and a relationship of 0.1<(C+A)/Z<1 are simultaneously satisfied. As the area is increased, resistance reduction may be increased.

As an example, each of the conductive external area (C) of the positive electrode body portion and the conductive external area (A) of the negative electrode body portion may be 30% to 50% of the total external area (Z) of the unit battery. As each of the conductive external area (C) of the positive electrode body portion and the conductive external area (A) of the negative electrode body portion reaches 50% of the total external area (Z) of the unit battery, the ratio in area of the positive electrode body portion and the negative electrode body portion to the cell case may be further increased.

In the unit battery according to the present invention, the positive electrode body portion and the negative electrode body portion form one surface and the other surface of the cell case, respectively, whereby large-area electrode terminals are implemented. Preferably, when the unit battery is viewed from one surface, the positive electrode body portion is seen as having a size equivalent to 80% to 100% of the size of the outer surface of the unit battery, and when the unit battery is viewed from the other surface, the negative electrode body portion is seen as having a size equivalent to 80% to 100% of the size of the outer surface of the unit battery. More preferably, when the unit battery is viewed from one surface, the negative electrode body portion is not visible, and when the unit battery is viewed from the other surface, the positive electrode body portion is not visible.

In order to maximize the area of each of the positive electrode body portion and the negative electrode body portion of the cell case, for example, the positive electrode body portion may form one surface of the cell case and at least some of outer surfaces adjacent to one surface, and the negative electrode body portion may form the other surface of the cell case and at least some of outer surfaces adjacent to the other surface.

The material for each of the positive electrode body portion and the negative electrode body portion is not particularly restricted as long as each of the positive electrode body portion and the negative electrode body portion is electrically connected to a corresponding one of the positive electrode and the negative electrode of the electrode assembly to constitute an electrode terminal for external connection while forming a part of the cell case. For example, each of the positive electrode body portion and the negative electrode body portion may be made of a metal plate. As an example, the metal plate may be made of stainless steel; however, the present invention is not limited thereto.

Preferably, each of the positive electrode body portion and the negative electrode body portion is made of a metal plate, and is located at each of the outermost sides of the battery so as to be capable of being individually handled, whereby it is possible to simplify the structure of the pack/module. In order to increase mechanical strength, reduce resistance, and improve thermal conductivity in this structure, it is preferable for the metal plate to have a thickness of 50 um or more. If the thickness of the outermost metal plate at which individual battery handling is possible is too small, there is a danger, such as damage, and it may be difficult to increase mechanical strength, reduce resistance, and improve thermal conductivity in order to simplify the structure of the pack/module. Depending on circumstances, it is possible to form a linear or nonlinear pattern in order to increase the mechanical strength. In this case, the surface area may be increased through a male-female engagement structure at a region at which the positive electrode body portion and the negative electrode body portion, which are terminals of the battery, contact each other, whereby it is possible to further reduce the electrical resistance.

In a concrete example, the insulation portion may be located between the positive electrode body portion and the negative electrode body portion along outer surfaces of the cell case adjacent to one surface and the other surface, whereby it is possible to guarantee electrical insulation between the positive electrode body portion and the negative electrode body portion while minimizing the ratio in size of each of the positive electrode body portion and the negative electrode body portion to the cell case.

The insulation portion may be made of a material that has an electrical insulation effect, such as polypropylene (PP), polyethylene (PE), or polyimide; however, the material for the insulation portion is not particularly restricted as long as the material exhibits excellent electrical insulation and excellent shapeability.

The thickness of the insulation portion may be changed depending on the voltage of the unit battery suitable for purpose. For example, the thickness of the insulation portion may be determined based on breakdown voltage V_{b} thereof. The use voltage of the unit battery may be variously changed. For example, the use voltage of the unit battery in the IT field may be 3 to 13 V, the use voltage of the unit battery in the automotive field may be 100 to 400 V, the use voltage of the unit battery in the high-performance vehicle field may be 800 to 900 V, the use voltage of the unit battery in the home ESS field may be 48 to 60 V, and the use voltage of the unit battery in the industrial ESS field may be 800 to 3000 V. Consequently, optimization and design suitable for each use are important. When the insulation material and the voltage are selected, the breakdown voltage of the insulation portion may be checked, whereby the thickness of the insulation portion may be calculated. In general, a polymer has a breakdown voltage of 100 to 300 kV/cm, and air has an average breakdown voltage of 30 kV/cm, which varies depending on humidity.

The insulation portion may have various shapes. In order to form a seal, an insulation layer that envelopes the edge of each of the positive electrode body portion and the negative electrode body portion, a sealing adhesive or sealing tape added between the positive electrode body portion and the negative electrode body portion may be used; however, the shape of the insulation portion is not particularly restricted.

In a concrete example, at least one of the positive electrode body portion and the negative electrode body portion may be configured to have a structure in which an insulative resin is added to an outer circumferential surface of a conductive plate. For example, this structure may be formed by insert injection molding; however, the present invention is not limited thereto.

In another concrete example, an insulative coating may be applied to at least one of the positive electrode body portion and the negative electrode body portion such that a part of the conductive body portion is exposed to the outside. The insulative coating may provide work convenience during handling of the unit battery for manufacture of battery modules or battery packs.

Preferably, in the above structure, the insulative coating is formed along the outer circumferential surface of the conductive body portion such that a central region of the conductive body portion is exposed to the outside.

As previously described, the unit battery according to the present invention is preferably used to manufacture a high-capacity, high-current battery module or battery pack. For example, the unit battery may be a high-capacity secondary battery having a capacity of 10 Ah or more or a high-current secondary battery having a current of 0.5 C or more.

In addition, the present invention provides a battery module including two or more unit batteries electrically connected to each other.

For example, in the battery module, adjacent ones of the unit batteries may be electrically connected to each other in the state in which the positive electrode body portion and the negative electrode body portion are in direct physical contact with each other. In this case, a connection member, such as welding, a wire harness, or a busbar, is not necessary for electrical connection, whereby it is possible to very easily manufacture the battery module. In addition, when the battery module is disassembled for reuse or recycling, it is possible to obtain the unit batteries without damage.

In a concrete example, the battery module may further include a cooling plate or a cooling pad disposed in physical contact with at least one of the positive electrode body portion and the negative electrode body portion of each of the unit batteries, whereby it is possible to improve efficiency in cooling of the battery module.

In addition, the present invention provides a battery pack including one or more battery modules. Other constructions of the battery module and the battery pack and the method of manufacturing the same are known in the art to which the present invention pertains, and therefore a detailed description thereof will be omitted.

### Effects of the Invention

As is apparent from the above description, a unit battery for manufacture of battery modules or battery packs according to the present invention has advantages in that the energy density is high and the electrical resistance is minimized, whereby it is possible to easily manufacture a large-capacity, high-energy-density battery module or battery pack, in that a positive electrode body portion and a negative electrode body portion, each of which serves as an electrode terminal, are located at the outermost sides of the unit battery, at which the unit battery is handled, in that the unit battery provides strength essential during a handling process, in that large-area contact is achieved without provision of an additional tab structure, in that electrical conductivity and thermal conductivity are excellent, whereby it is possible to minimize generation of heat, and in that the unit battery can be reused or recycled after use thereof.

### BRIEF DESCRIPTION OF DRAWINGS

The above and other objects, features and other advantages of the present invention will be more clearly understood from the following detailed description taken in conjunction with the accompanying drawings, in which:

FIG. 1A is a plan view schematically showing a conventional exemplary pouch-shaped battery;

FIG. 1B is a plan view schematically showing another conventional exemplary pouch-shaped battery;

FIGS. 2A and 2B are perspective views schematically showing battery modules manufactured using the pouch-shaped unit batteries of FIGS. 1A and 1B, respectively;

FIG. 3 is a plan view schematically showing a structure in which a cooling unit is mounted in the battery module of FIG. 2A;

FIG. 4 is a perspective view schematically showing a conventional exemplary prismatic battery;

FIG. 5 is a perspective view schematically showing a battery module manufactured using the prismatic unit battery of FIG. 4;

FIG. 6A is a front view, a rear view, and a side view schematically showing a unit battery according to an embodiment of the present invention;

FIG. 6B is a sectional view taken along line X-X of FIG. 6A;

FIGS. 7A is a partial plan view schematically showing a battery module manufactured using the unit batteries of FIG. 6A;

FIGS. 7B to 7F are perspective views schematically showing examples in which battery modules are connected to each other in parallel or in series to constitute a battery pack;

FIG. 8A is a plan view schematically showing a structure in which a cooling unit is mounted in the battery module of FIG. 7A;

FIG. 8B is a schematic view showing the external shape of the battery module of FIG. 7B; and

FIG. 9 is a front view, a rear view, and a side view schematically showing a unit battery according to another embodiment of the present invention.

### DETAILED DESCRIPTION OF THE INVENTION

Hereinafter, embodiments of the present invention will be described in detail with reference to the accompanying drawings; however, the category of the present invention is not limited thereto.

First, conventional batteries will be described with reference to the accompanying drawings.

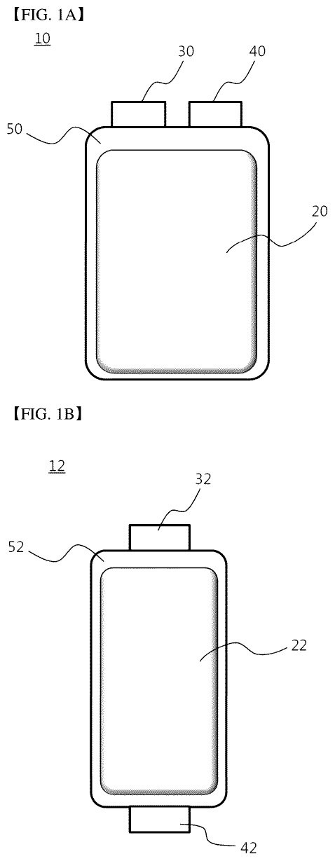

FIGS. 1 to 5 are schematic views showing the structure of a conventional pouch-shaped battery (polymer battery), the structure of a conventional prismatic battery, a battery module manufactured by electrically connecting a plurality of pouch-shaped batteries to each other, and a battery module manufactured by electrically connecting a plurality of prismatic batteries to each other, respectively.

Referring to FIGS. 1A and 1B, a pouch-shaped battery 10 or 12 has a structure in which an electrode assembly (not shown) configured to be charged and discharged is received in a receiving portion 20 or 22 of a pouch-shaped case together with an electrolytic solution and in which a positive electrode terminal 30 or 32 and a negative electrode terminal 40 or 42 protrude from one end or opposite ends of the pouch-shaped case.

The pouch-shaped case is constituted by a metal layer and a resin layer added to each of opposite surfaces of the metal layer, and a sealed portion 50 or 52 thermally fused in order to hermetically seal the receiving portion 20 or 22 is formed at the pouch-shaped case so as to have a predetermined size.

In the pouch-shaped battery 10 or 12, energy storage capacity substantially depends on the size of the receiving portion 20 or 22. Consequently, the energy density of the battery 10 or 12 based on the total size thereof is reduced due to the positive electrode terminal 30 or 32, the negative electrode terminal 40 or 42, and the sealed portion 50 or 52, and the resistance of the battery 10 or 12 is increased due to small sizes of the positive electrode terminal 30 or 32 and the negative electrode terminal 40 or 42.

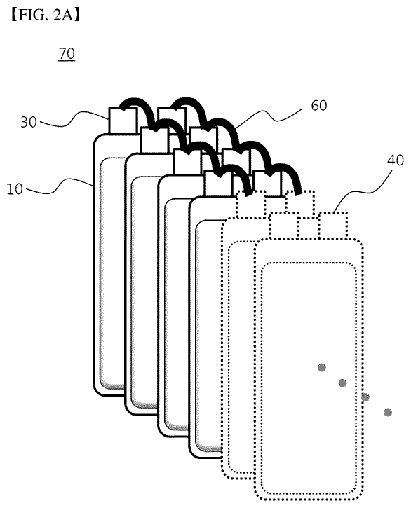

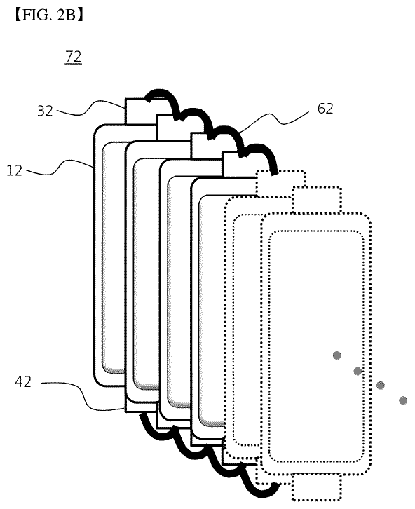

When a plurality of pouch-shaped unit batteries 10 or 12 is electrically connected to each other in order to constitute a battery module 70 or 72, as shown in FIGS. 2A and 2B, the positive electrode terminal 30 or 32 and the negative electrode terminal 40 or 42 must be connected to each other using a wire or a busbar 60 or 62. Consequently, it is necessary to secure a space for welding of the wire or the busbar 60 or 62, and the resistance of weld portions is also increased.

For these reasons, technology for stacking individual unit batteries 10 or 12 in a state of being mounted on a separate frame member (not shown) has been proposed; however, various problems naturally occur due to addition of the frame member.

Also, it is necessary to remove heat generated during charging and discharging of the battery module. As shown in FIG. 3, a cooling unit 80 must be brought into contact with one end of the battery module 70. The cooling unit 80 is constituted by a cooling insulation layer 80a abutting the unit batteries 10 and a cooling plate 80b abutting the cooling insulation layer 80a, and a refrigerant, such as a coolant 80c, flows in the cooling plate 80b.

In the battery module 70, heat is mainly generated from the positive electrode terminal 30 and the negative electrode terminal 40. Since the cooling unit 80 cannot be installed at the portions from which heat is mainly generated due to structural limits, however, cooling efficiency is greatly lowered.

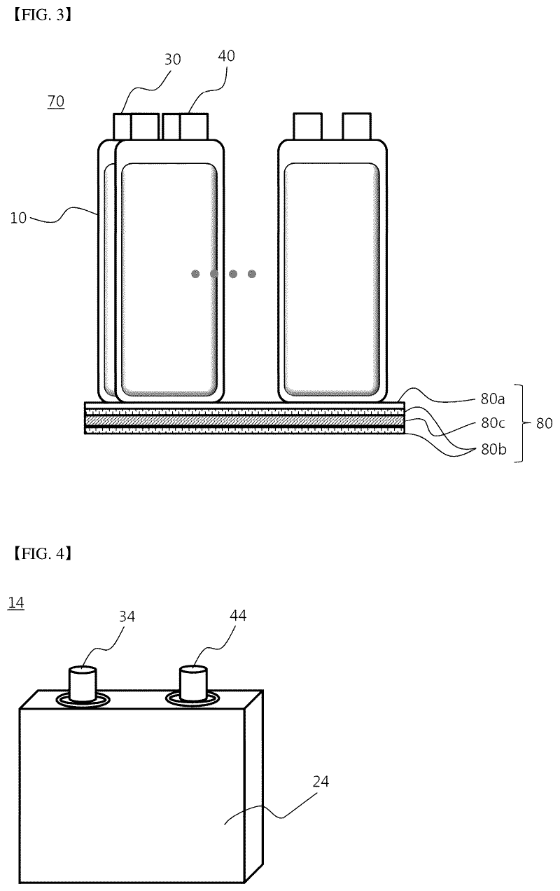

Referring to FIGS. 4 and 5, a prismatic battery 14 and a battery module 64 manufactured using the prismatic battery 14 are schematically shown.

Referring to these figures, the prismatic battery 14 is configured to have a structure in which an electrode assembly (not shown) configured to be charged and discharged is received in a prismatic metal can 24 together with an electrolytic solution and in which a positive electrode terminal 34 and a negative electrode terminal 44 protrude from one end of the metal can 24.

In the same manner as the pouch-shaped battery described above, the energy density of the prismatic battery 14 is also reduced due to a dead space formed by the positive electrode terminal 34 and a negative electrode terminal 44, which protrude outwards, and the resistance of the prismatic battery 14 is increased due to small sizes of the terminals.

In addition, when a battery module 74 is manufactured using a plurality of prismatic batteries 14, it is necessary to provide a space for welding of a connection member 64, such as a wire or a busbar, and the resistance of weld portions is also increased.

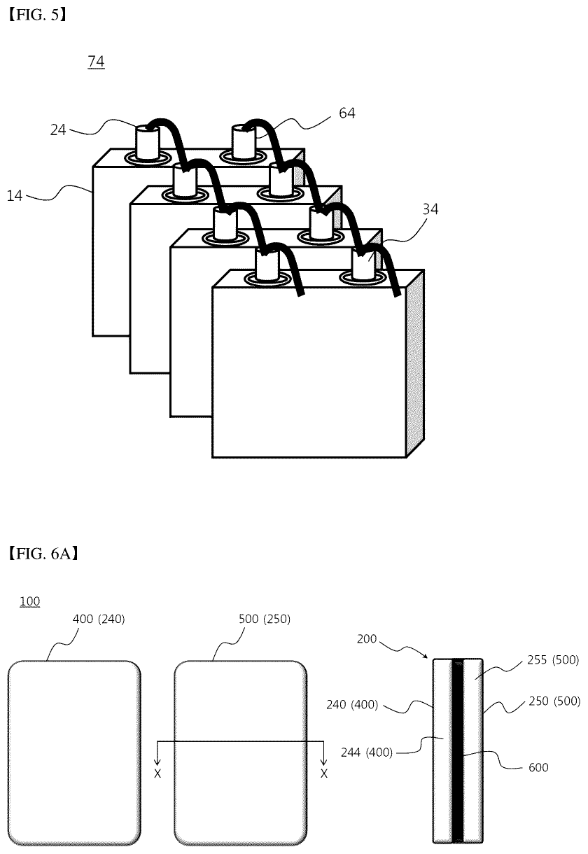

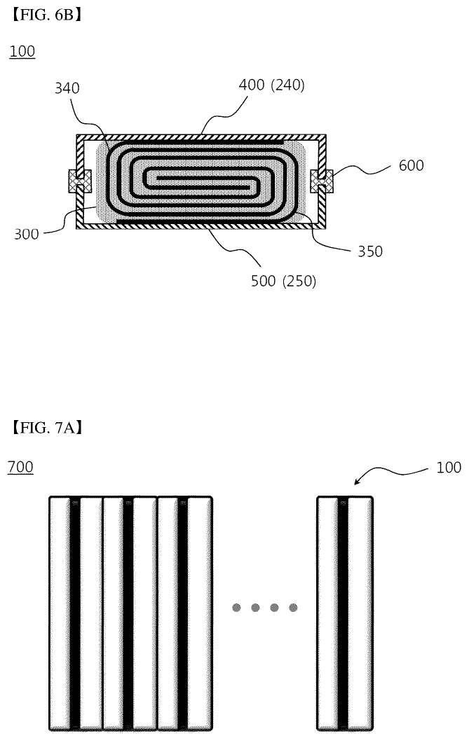

FIG. 6A is a front view, a rear view, and a side view schematically showing a unit battery according to an embodiment of the present invention, and FIG. 6B is a schematic sectional view taken along line X-X of FIG. 6A.

Referring to FIGS. 6A and 6B, the unit battery 100 includes an electrode assembly 300 mounted in a cell case 200, the electrode assembly 300 being capable of being reversibly charged and discharged, a positive electrode body portion 400, to which a positive electrode 340 of the electrode assembly 300 is connected, the positive electrode body portion 400 being configured to serve as a positive electrode terminal for external connection while forming one surface 240 of the cell case 200, a negative electrode body portion 500, to which a negative electrode 350 of the electrode assembly 300 is connected, the negative electrode body portion 500 being configured to serve as a negative electrode terminal for external connection while forming the other surface 250 of the cell case 200, and an insulation portion 600 configured to electrically insulate the positive electrode body portion 400 and the negative electrode body portion 500 from each other.

As a result, the cell case 200 is apparently constituted by the positive electrode body portion 400, the negative electrode body portion 500, and the insulation portion 600. Consequently, the positive electrode body portion 400 forms one surface 240 of the cell case 200, and the negative electrode body portion 500 forms the other surface 250 of the cell case 200.

The cell case 200 is formed in the shape of a rectangular parallelepiped, and one surface 240 of the positive electrode body portion 400 and the other surface 250 of the negative electrode body portion 500 are symmetric with respect to the center of the rectangular parallelepiped while having the largest area.

When the unit battery 100 is viewed from one surface 240 of the positive electrode body portion 400, therefore, only the positive electrode body portion 400 is substantially seen, and the negative electrode body portion 500 is not visible. When the unit battery 100 is viewed from other surface 250 of the negative electrode body portion 500, on the other hand, only the negative electrode body portion 500 is substantially seen, and the positive electrode body portion 400 is not visible.

In addition, when the unit battery 100 is viewed from the side, the positive electrode body portion 400 extends to form a part 244 of an outer surface adjacent to one surface 240 of the cell case 200, and the negative electrode body portion 500 extends to form a part 255 of the outer surface adjacent to the other surface 250 of the cell case 200. As a result, each of the positive electrode body portion 400 and the negative electrode body portion 500 is formed so as to be larger than a corresponding one of the surfaces of the cell case 200, which is a rectangular parallelepiped.

The insulation portion 600 is disposed at the interface between the positive electrode body portion 400 and the negative electrode body portion 500, and the insulation portion 600 is configured to have a structure in which an insulative resin is added to an outer circumferential surface of a conductive plate constituting each of the positive electrode body portion 400 and the negative electrode body portion 500.

Since the positive electrode terminal and the negative electrode terminal do not protrude outwards from a main body of the unit battery 100, as described above, no dead space is formed, whereby it is possible to maximize energy density. In addition, since one surface 240 and the other surface 250, which are large outer surfaces, of the cell case 200, which is a rectangular parallelepiped, substantially serve as the positive electrode terminal and the negative electrode terminal, respectively, increase in resistance is not caused, and cooling efficiency is high.

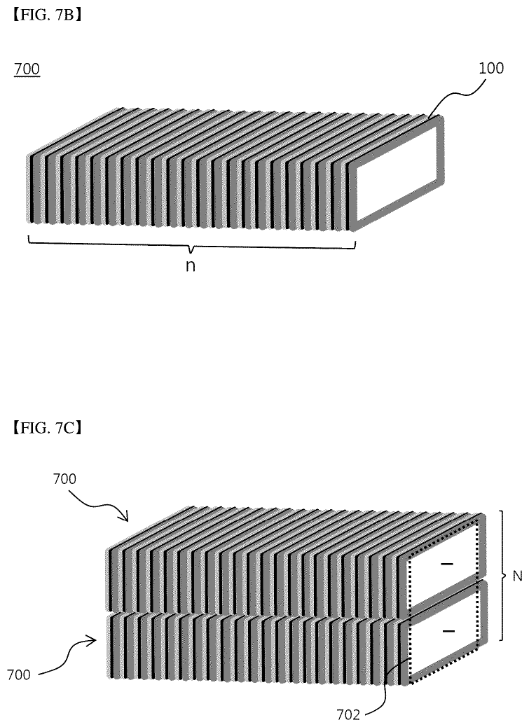

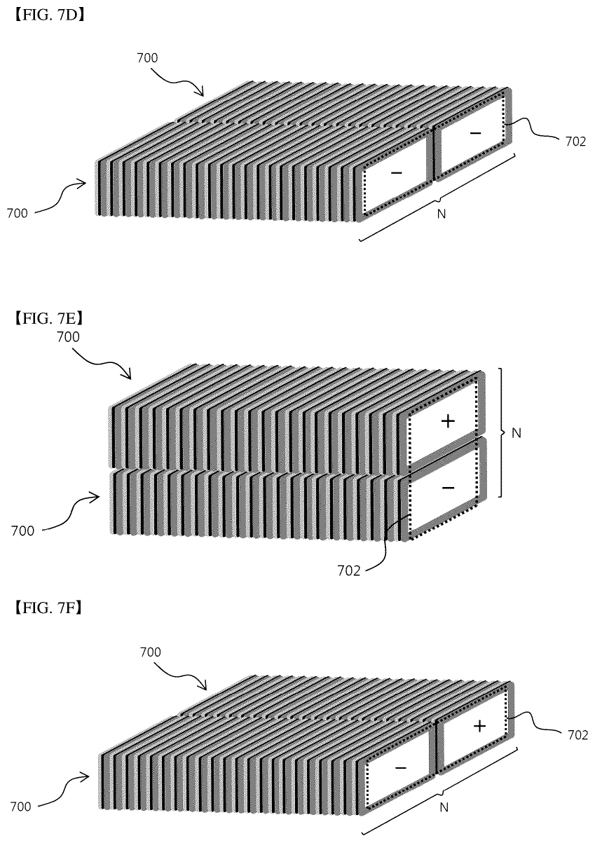

As shown in FIGS. 7A to 7F, unit batteries 100 may be electrically connected to each other only through physical contact therebetween without using a separate connection member, such as a wire or a busbar, and therefore it is possible to very easily manufacture a battery module 700. In addition, electrical connection between the unit batteries may be achieved through large-area contact without using a separate connection member, such as a wire or a busbar, and therefore it is possible to reduce contact resistance.

Referring to FIG. 7B, two or more (n being a natural number equal to or greater than 2) unit batteries may be connected to each other in series to constitute a battery module 700 having desired voltage. For example, when 96 (n=96) unit batteries 100 having an average voltage of 3.8 V are connected to each other in series, it is possible to manufacture a battery module 700 having a voltage of 300 to 400 V, which is necessary to manufacture a battery pack required for a general electric vehicle (EV).

When a plurality (n being a natural number equal to or greater than 2) of battery modules 700 is connected to each other in parallel, as shown in FIG. 7C or 7D, it is possible to increase the capacity thereof. On the other hand, when a plurality (n being a natural number equal to or greater than 2) of battery modules 700 is connected to each other in series, as shown in FIG. 7E or 7F, it is possible to increase the voltage thereof.

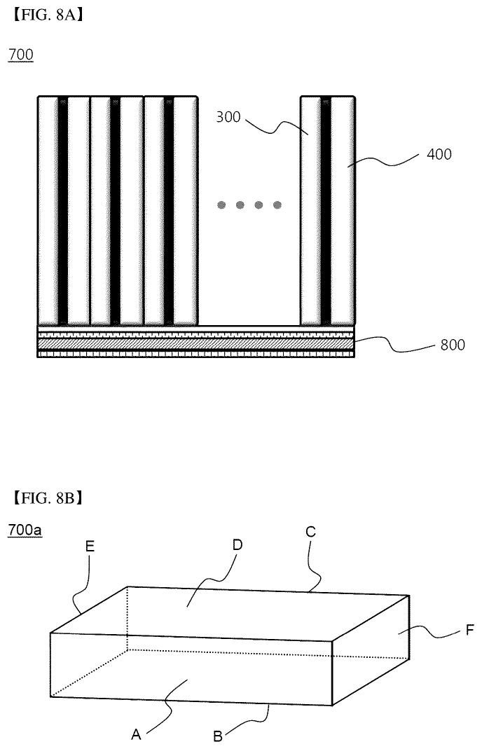

For example, when seven or eight battery modules 700 are connected to each other in series, the battery modules may be used in a home solar system or a low voltage power boosting stop and go vehicle system, and it is also possible to manufacture an insulated gate bipolar transistor (IGBT) for energy storage systems (ESS) having a voltage of 900 to 1000 V. Electrical connection between the battery modules 700 may be achieved by connection or welding between end plates mounted to opposite ends of the battery module assembly. In addition, when a cooling unit 800 is added to one side of the battery module 700, as shown in FIG. 8A, the cooling unit can be brought into direction contact with the positive electrode body portion 400 and the negative electrode body portion 50, which are electrode terminals, of each unit battery 100, whereby it is possible to achieve excellent cooling efficiency.

Specifically, since the battery module has an approximately rectangular parallelepiped structure, as shown in FIG. 7A, the rectangular parallelepiped battery module 700a has six faces A, B, C, D, E, and F, as can be seen from FIG. 8B. This shape may be identically applied to a battery pack.

As shown in FIG. 8A, the cooling plate may be added to at least one of the faces A, B, C, and D of the battery module 700a, which have relatively large areas. Although it is possible to cool the faces E and F, configuration with avoidance of electrical connection may not be easy, and cooling efficiency thereof may be lower than in the faces A, B, C, and D.

An end plate having a connection member (e.g. a metal plate) connected to or brought into contact with a corresponding one of the terminals of the unit battery is located at each of the faces E and F, and a member for insulation from the outside, e.g. a paint material including ceramic or a polymer film, is installed at each of the faces A, B, C, D, E, and F.

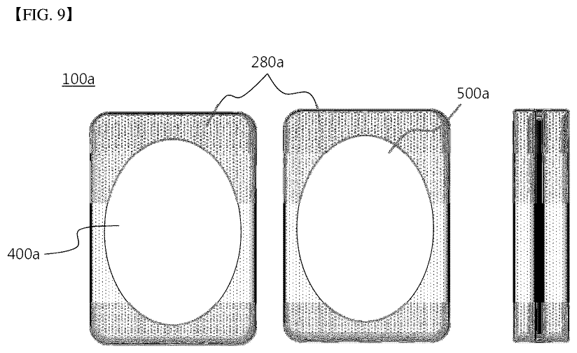

FIG. 9 is a front view, a rear view, and a side view schematically showing a unit battery 100a according to another embodiment of the present invention.

Referring to FIG. 9, the unit battery 100a is different from the unit battery 100 of FIG. 6A in that an insulative coating 280a is applied along an outer circumferential surface of each of a positive electrode body portion 400a and a negative electrode body portion 500a such that a central region of each of the positive electrode body portion and the negative electrode body portion is exposed to the outside.

The insulative coating 280a of the unit battery 100a reduces danger of electric shock during handling of the unit battery 100a for manufacture of battery modules or battery packs, whereby work convenience is improved.

Those skilled in the art to which the present invention pertains will appreciate that various applications and modifications are possible within the category of the present invention based on the above description.

1. A unit battery for manufacture of battery modules or battery packs, the unit battery comprising:
an electrode assembly mounted in a cell case, the electrode assembly being capable of being reversibly charged and discharged;
a positive electrode body portion, to which a positive electrode of the electrode assembly is connected, the positive electrode body portion being configured to serve as a positive electrode terminal for external connection while forming one surface of the cell case;
a negative electrode body portion, to which a negative electrode of the electrode assembly is connected, the negative electrode body portion being configured to serve as a negative electrode terminal for external connection while forming the other surface of the cell case; and
an insulation portion configured to electrically insulate the positive electrode body portion and the negative electrode body portion from each other.

2. The unit battery according to claim 1, wherein
the cell case is formed in the shape of a hexahedron, and
the one surface and the other surface are outer surfaces opposite each other based on a center of the hexahedron.

3. The unit battery according to claim 2, wherein the one surface and the other surface are two outer surfaces having relatively large areas, among six faces of the cell case.

4. The unit battery according to claim 1, wherein a total external area (Z) of the unit battery and a difference between a conductive external area (C) of the positive electrode body portion and a conductive external area (A) of the negative electrode body portion satisfy a relationship of 0≤|(C−A)/Z|<0.5.

5. The unit battery according to claim 1, wherein a conductive external area (C) of the positive electrode body portion, a conductive external area (A) of the negative electrode body portion, and a total external area (Z) of the unit battery satisfy a relationship of 0.1<(C+A)/Z<1.

6. The unit battery according to claim 1, wherein a total external area (Z) of the unit battery and a difference between a conductive external area (C) of the positive electrode body portion and a conductive external area (A) of the negative electrode body portion simultaneously satisfy a relationship of 0<|(C−A)/Z|<0.5 and a relationship of 0.1<(C+A)/Z<1.

7. The unit battery according to claim 1, wherein
when the unit battery is viewed from the one surface, the positive electrode body portion is seen as having a size equivalent to 80% to 100% of a size of an outer surface of the unit battery, and
when the unit battery is viewed from the other surface, the negative electrode body portion is seen as having a size equivalent to 80% to 100% of the size of the outer surface of the unit battery.

8. The unit battery according to claim 1, wherein each of the positive electrode body portion and the negative electrode body portion is made of a metal plate.

9. The unit battery according to claim 1, wherein at least one of the positive electrode body portion and the negative electrode body portion is configured to have a structure in which an insulative resin is added to an outer circumferential surface of a conductive plate.

10. The unit battery according to claim 1, wherein an insulative coating is applied to at least one of the positive electrode body portion and the negative electrode body portion such that a part of the conductive body portion is exposed to an outside.

11. The unit battery according to claim 1, wherein
the positive electrode body portion forms the one surface of the cell case and at least some of outer surfaces adjacent to the one surface, and
the negative electrode body portion forms the other surface of the cell case and at least some of outer surfaces adjacent to the other surface.

12. The unit battery according to claim 1, wherein the insulation portion is located between the positive electrode body portion and the negative electrode body portion along outer surfaces of the cell case adjacent to the one surface and the other surface.

13. The unit battery according to claim 1, wherein the unit battery is a high-capacity secondary battery having a capacity of 10 Ah or more or a high-current secondary battery having a current of 0.5 C or more.

14. A battery module comprising two or more unit batteries according to claim 1.

15. The battery module according to claim 14, wherein adjacent ones of the unit batteries are electrically connected to each other in a state in which the positive electrode body portion and the negative electrode body portion are in direct physical contact with each other.

16. The battery module according to claim 14, further comprising a cooling plate or a cooling pad disposed in physical contact with at least one of the positive electrode body portion and the negative electrode body portion of each of the unit batteries.

17. A battery pack comprising one or more battery modules according to claim 14.
